(19) United States
(12) Patent Application Publication
(10) Pub. No.: US 2015/0120431 A1
(43) Pub. Date: Apr. 30, 2015

(54) System and Method for In-Store Printing of Coupons Selected from a Remote Computing Device

(71) Applicant: Javier Armando Arroyo-Figueroa, Gainesville, FL (US)

(72) Inventor: Javier Armando Arroyo-Figueroa, Gainesville, FL (US)

(73) Assignee: ENTEVIA, LLC, Gainesville, FL (US)

(21) Appl. No.: 14/064,178

(22) Filed: Oct. 27, 2013

(51) Int. Cl. G06Q 30/02; G06K 15/00; H04W 4/14

(52) U.S. Cl. CPC G06Q 30/0237; H04W 4/14; G06K 15/00
USPC 705/14.37

(57) ABSTRACT

A system and method for in-store printing of coupons selected from a remote computing device, such as a smart phone, or a home computer. Users register their mobile phone numbers into the system's web site; once coupons are selected, an access code is sent by SMS (“text message”) to the user's registered mobile phone. The user then goes to a selected store to print the coupons in a dispensing kiosk, using his/her mobile phone number and the access code that was sent to it. Printed coupons expire the same date they are printed, and should be redeemed the same day in the store they are printed. Each coupon will have printed a GS1 databar code containing information that can be used for market analysis purposes.

### 1. TECHNICAL FIELD

The present invention relates to the field of computing, more specifically to a hardware/software-based system and method for in-store printing of coupons selected from a remote computing device.

### 2. BACKGROUND

With the increasing popularity of mobile devices connected to the world-wide-web, there is an increasing interest in distributing coupons via mobile devices. However, retailers of consumer package goods (CPG) (e.g., supermarkets) face major problems in the process of adoption of this new technology. First, acceptance of coupons displayed in mobile devices pose technical hurdles, such as readability of the barcodes displayed in different types of mobile devices, each one with different degrees of display clarity. Second, the investment required to adopt this scanning technology is estimated at $500 per checkout station. Third, there are operational costs caused by the delays doe to the handling of the customer's mobile phone and scanning the appropriate bar codes, which requires additional training for the checkout personnel.

### 3. BRIEF SUMMARY

The invention is a system and method for in-store printing of coupons selected from a remote computing device, such as a smart phone, or a home computer. Users register their mobile phone numbers into the system's web site; once coupons are selected, an access code is sent by SMS (“text message”) to the user's registered mobile phone. The user then goes to a selected store to print the coupons in a dispensing kiosk, using his/her mobile phone number and the access code that was sent to it. Printed coupons expire the same date they are printed, and should be redeemed the same day in the store they are printed. Each coupon will have printed a GS1 databar code containing information that can be used for market analysis purposes.

### 4. BRIEF DESCRIPTION OF THE DRAWINGS

FIG. 1. System Architecture

FIG. 2. Registration Process (UML Activity Diagram)

FIG. 3. Coupon Selection Process (UML Activity Diagram)

FIG. 4. Coupon Printing Process (UML Activity Diagram)

### 5. DETAILED DESCRIPTION

### 5.1. System Architecture

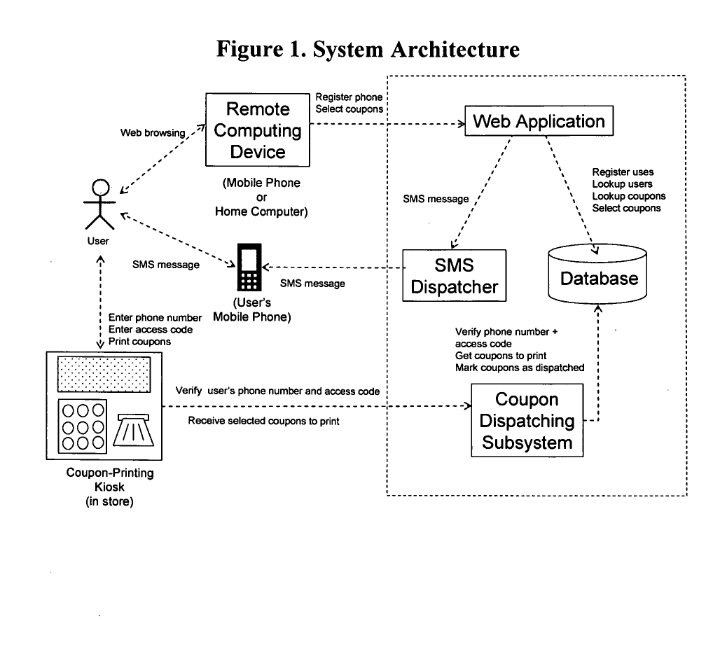

A diagram depicting the system architecture is presented in FIG. 1. The following is a description of the system components and their relationships:
User: The main actor of the system is the User, who does web browsing through a Remote Computing Device and obtains coupon-printing information through his/her Mobile Device. The User prints the selected coupons by entering his/her mobile phone number and access code in the Coupon-Printing Kiosk.
Remote Computing Device: A Remote Computing Device can be the User's smart phone or any web-enabled computer, such as the User's home computer. The remote computing device is used to register the User's mobile phone number into the system, and to select the coupons to be printed.
Data Center: Many system components are located and managed at a Data Center, including a Web Application, a Database, an SMS Dispatcher and a Coupon Dispatching Subsystem.
Web Application: The system provides a web application with the following functionalities: (i) register a user's mobile phone number; (ii) display available coupons based on the user's profile; (iii) select coupons to be printed; and (iv) send an access code to the user's registered mobile phone number (via the SMS Dispatcher).
SMS Dispatcher: This component is responsible for sending SMS messages to the registered users. SMS messages are used to send to the user the access code to print the selected coupons, as well as to send validation codes to register new users.
User's Mobile Phone: The User's mobile phone number is used to receive SMS messages. If it is a smart phone, it may also be used as a browser to access the Web Application
Database: A Database is used to store: (i) user's information, such as phone number, encrypted password, year of birth and gender; (ii) coupon information, such as manufacturer, brand, offer description and GS1-databar barcode data; (iii) participant store information, such as store name and location; (iv) selected coupons; (v) printed coupons.
Coupon-Printing Kiosk: A Coupon-Printing Kiosk is located at each participant store. The kiosk consists of an LCD display, a numeric key pad and a thermal receipt printer; all connected to a computer with Wi-Fi network capabilities. The kiosk's computer accesses the Data Center via the Wi-Fi network. The thermal receipt printer is used to print the coupons that were previously selected by the User.
Coupon Dispatching Subsystem: A Coupon Dispatching Subsystem is responsible for obtaining the information of the selected coupons from a Database, formatting the coupons according to coupon printing standards, and returning the printing data to the Coupon-Printing Kiosk.

### 5.2. Registration Process

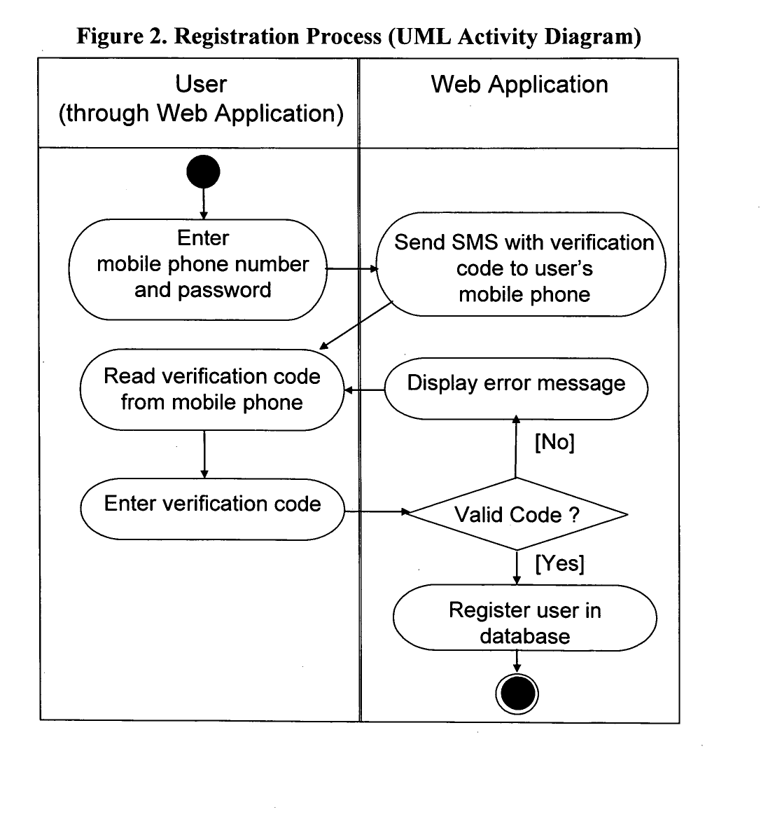

A UML Activity diagram depicting the Registration Process is presented in FIG. 2. The process starts by the User accessing the Web Application's registration functionality. The User, through the system's Web Application, registers by entering his/her mobile phone number, and selecting a password. An SMS message is sent to the User's mobile phone, containing an access code. The User reads the access code from the mobile phone, and enters it into the Web Application. The User's mobile phone number will be registered only if a valid code is entered. To enhance the system security, the following measures shall be taken:
1. If an invalid access code is entered, there shall be a five-second delay before an error message is displayed.
2. No more than three SMS messages can be sent in a 5-minute interval from the same remote device.
3. A captcha image with a human-readable (but machine-unreadable) code shall be displayed, and the User shall be asked to enter such code in the registration page.

### 5.3. Coupon Selection Process

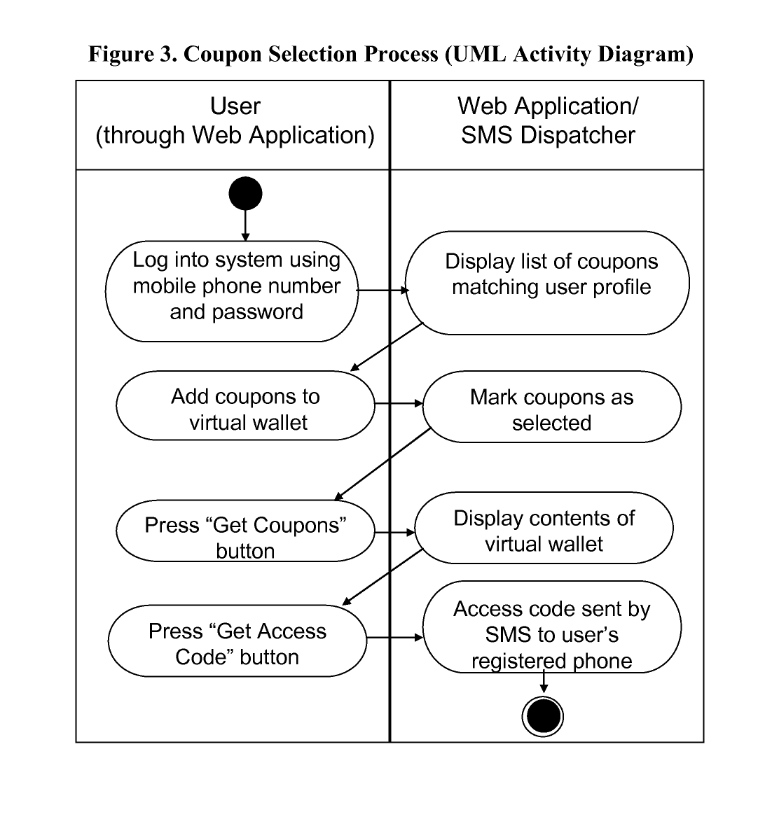

A UML Activity diagram depicting the Coupon Selection Process is presented in FIG. 3. The process starts by the User accessing the Web Application's coupon selection functionality. The User logs into the system using his/her mobile phone number and password (as assumed to be previously registered). Upon a successful login, the web application displays a list of coupons that match the User's profile (birth year, gender and coupons previously selected). The User selects the desired coupons, which are added to a “virtual wallet”, and marked as selected by the Web Application. The User pressed the “Get Coupons” button, and the Web Application displays the contents of the virtual wallet (list of selected coupons). The virtual wallet will ask the User to update his/her demographics data, such as birth year and gender. The user presses the “Get Access Code” button in the virtual wallet, after which event the Web Application sends the access code by means of an SMS message to the User's registered mobile phone.

### 5.4. Coupon Printing Process

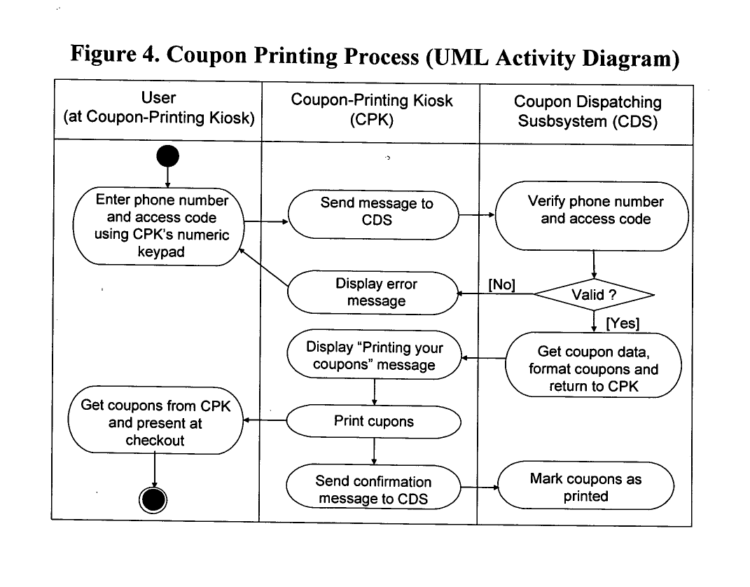

A UML Activity diagram depicting the Coupon Printing Process is presented in FIG. 4. The process starts by the User accessing a Coupon-Printing Kiosk (CPK) at a participating store. The User enters his/her mobile phone number and the access code that was sent by SMS, using the CPK's numeric keypad. The CPK sends a message to the Coupon Dispatching Subsystem (CDS), containing the mobile phone number and access code entered by the User. The CDS verifies the mobile phone number and access code. If the numbers are invalid, an error code will be returned by the CDS to the CPS, which will in turn display an error message to the user. Coupons will be printed only if a valid mobile phone number/access code combination is entered. If a valid combination was entered, the CDS will obtain the coupon data from the database, format the coupons and return the data to the CPK. Upon receiving the coupon data, the CPK will display the “Printing your coupons . . . ” message, and will print the coupons in the CPK's thermal receipt printer. After the coupons are printed, a confirmation message is sent by the CPK to the CDS, which in turns mark the coupons as printed. The process terminates when the User gets the coupons from the CPK and present them at checkout. To motivate the usage of coupons at the store, coupons will expire the same day they are printed, and will have the store's logo imprinted. Coupons are printed according to the GS1 US “North American Coupon Application Guidelines Using GS1 Databar (RSS) Expanded Symbols”.

What is claimed is:

1. A computer-based system for in-store printing coupons selected by a Remote Computing Device (such as a smart phone or any computing device with web-browsing capabilities), said system comprising:
a. A Web Application, accessible from any Remote Computing Device.
b. An SMS Dispatcher, with the capability of sending SMS messages to mobile phones.
c. A Database, with capabilities for storing data of user registrations, coupons, participating stores and manufacturers.
d. A Coupon Dispatching Subsystem, with capabilities of accessing the Database to obtain coupon data, format coupons and send formatted coupons to a Coupon-Printing Kiosk.
e. A set of Coupon-Printing Kiosks, each one located at a participant store, and each one comprising an LCD display, a numeric keypad, a thermal receipt printer and a computer with Wi-Fi network capabilities, connected through a Wi-Fi network to the Coupon Dispatching Subsystem.

2. The system of claim 1, wherein the User, through a Remote Computing Device, accesses the Web Application to register his/her mobile phone number, along with a password, to create a unique account for system access.

3. The system of claim 1, wherein the User, through a Remote Computing Device, accesses the Web Application and enters his/her registered phone number and password to: (i) obtain a list of coupons that match the User's profile; (ii) select coupons from the list for printing at a participating store; (iii) display the selected coupons; (iv) update the User's profile with birth year and gender; (v) send to the User's registered mobile phone, through the SMS Dispatcher, an SMS message containing an access code to be used for printing the selected coupons at a participating store.

4. The system of claim 1, wherein the User, through a Coupon-Printing Kiosk located at a participant store: (i) enters his/her mobile phone number and access code obtained from an SMS message; (ii) obtains the coupons associated with the User's mobile phone number, after the appropriate validation of the mobile phone number and access code has been performed by the Coupon-Printing Kiosk through the system's Coupon Dispatching Subsystem.

5. The system of claim 1, wherein coupons are printed according to the GS1 US “North American Coupon Application Guidelines Using GS1 Databar (RSS) Expanded Symbols”.
